(19) United States
(12) Patent Application Publication
(10) Pub. No.: US 2011/0246330 A1
(43) Pub. Date: Oct. 6, 2011

(54) SYSTEM AND METHOD FOR SEARCHING CONTENT

(76) Inventors: Anup Tikku, San Jose, CA (US); Matthew Scott Zises, San Jose, CA (US)

(21) Appl. No.: 12/752,958

(22) Filed: Apr. 1, 2010

(51) Int. Cl. G06Q 30/00; G06F 17/30; G06F 3/048

(52) U.S. Cl. 705/27.1; 707/758; 715/810; 707/E17.014; 707/E17.02; 707/E17.016

(57) ABSTRACT

In various example embodiments, a system and method for searching content is provided. A selection of an area of an image is received. Using one or more processors, an analysis is performed to determine one or more entities associated with the selected area. Content related to the determined one or more entities are retrieved from a database. The database may comprise a database of current content that is continually updated. The retrieved content is displayed in association with the selected area of the image. Further refinement of the retrieved content may be performed and a transaction based on the retrieved content may be concluded.

### FIELD

The present disclosure relates generally to image recognition, and in a specific example embodiment, to searching content.

### BACKGROUND

Websites and search engines typically allow a user to search for content based on textual inputs. For example, keyword searches may be used to search one or more databases. If a user inputs a “wrong” set of keywords or does not know what a particular item is called, the result would be an unsatisfactory search result set. Furthermore, it is often difficult for a user to determine the rights terms in order to obtain a result set that is correct and useful. As such, the user needs to spend more time refining their search with no guarantee that they will find the item the user has in mind. This results in wasted processing time and power as well as wasted bandwidth consumption.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system used to identify items depicted in images.

FIG. 2 is a block diagram illustrating an example embodiment of a publication system.

FIG. 3 is a block diagram illustrating an example embodiment of an imaging engine.

FIG. 4 is a flow diagram of an example high-level method for searching content.

FIG. 5 is a flow diagram of an example detailed method for performing content analysis.

FIG. 6 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

As used herein, the term “or” may be construed in either an inclusive or exclusive sense. Additionally, although various example embodiments discussed below focus on a network-based publication environment, the embodiments are given merely for clarity in disclosure. Thus, any type of electronic publication, electronic commerce, or electronic business system and method, including various system architectures, may employ various embodiments of the content system and method described herein and be considered as being within a scope of example embodiments. Each of a variety of example embodiments is discussed in detail below.

Example embodiments described herein provide systems and methods to search content based on an image from digital media (e.g., graphics, animation, video). A selection of an image and an area within the image is received. Using one or more processors, an analysis is performed to determine one or more entities (e.g., items, people) associated with the selected area within the image. In some embodiments, text embedded or contained within the image may also be used in the search. Content related to the determined one or more items are retrieved from a coupled database. The database may comprise a database of content that is continually updated. In various embodiments, the database may comprise, for example, an item inventory database of items available for purchase or a database containing information about people (e.g., a dating or social database). The retrieved content is displayed in association with the selected area of the image. For example, the retrieved content may be displayed in a feedback cloud or pop-up window immediately adjacent to the selected area.

In some embodiments, digital media depicting a variety of entities may be stored in a repository of, for example, a network-based publication system such as a network-based marketplace (e.g., an online shopping website or an online auction website) resulting in the image catalog. Various users may submit the digital media for inclusion in item postings, advertisements, feedback, comments, or other publications. Alternatively, the digital media may be an imported media from the client device 110 or a media from anywhere on the Internet.

It should be noted that various embodiments of the present invention may be used to access any type of content. For example, the content may be listings of items for sale or auction. As used herein, an “item” refers to any tangible or intangible thing or something that has a distinct, separate existence from other things (e.g., goods, services, electronic files, web pages, digital media, electronic documents, or land). Another example of content may be content from various data sources on a network, such as the Internet (e.g., a visual search engine for information such as articles on the Internet or webpages associated with the image). In yet further embodiments, the content may comprise information on people (e.g., social networking or dating content), places, or organizations (e.g., educational institutions). Any type of content associated with an image of the digital media may be returned to the user.

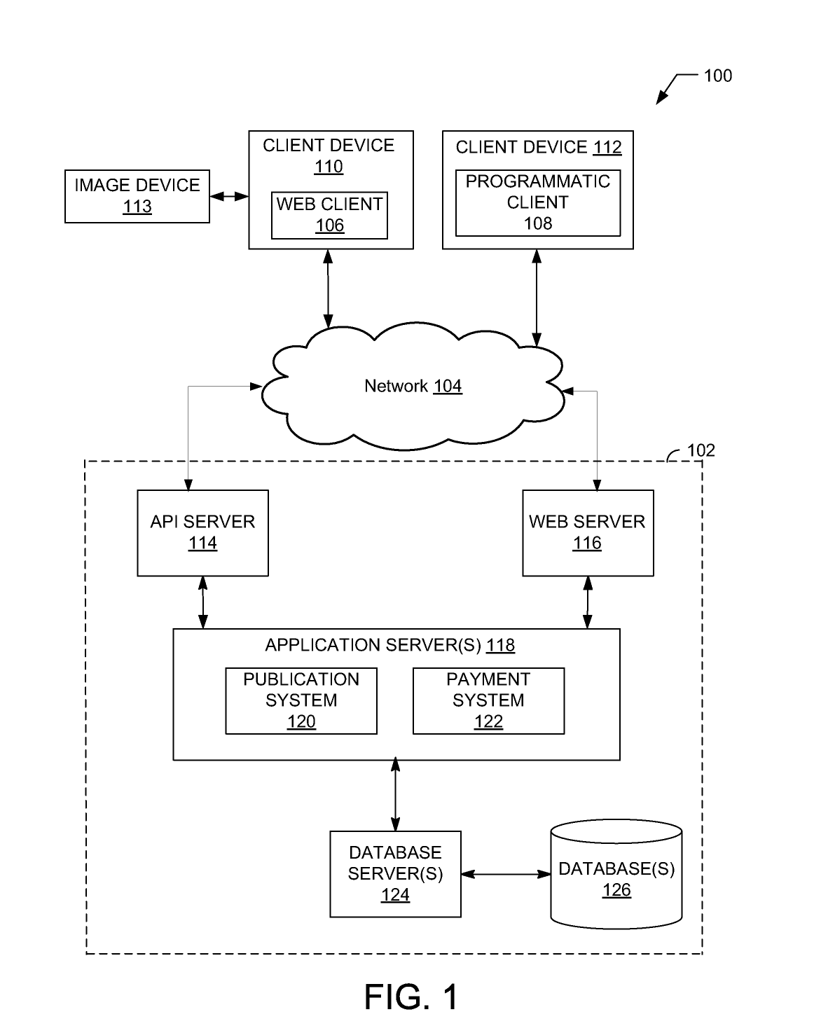

With reference to FIG. 1, an example embodiment of a high-level client-server-based network architecture 100 to provide content based on an image is shown. A networked system 102, in an example form of a network-server-side functionality, is coupled via a communication network 104 (e.g., the Internet, wireless network, cellular network, or a Wide Area Network (WAN)) to one or more client devices 110 and 112. FIG. 1 illustrates, for example, a web client 106 operating via a browser (e.g., such as the INTERNET EXPLORER® browser developed by Microsoft® Corporation of Redmond, Wash. State), and a programmatic client 108 executing on respective client devices 110 and 112.

The client devices 110 and 112 may comprise a mobile phone, desktop computer, laptop, or any other communication device that a user may utilize to access the networked system 102. In some embodiments, the client devices 110 may comprise or be connectable to an image capture device 113 (e.g., camera). The image capture device 113 may also be enabled to capture hand gestures or other physical activities that are inputs to the client device 110. The client device 110 may also comprise one or more of a voice recognition module (not shown) to receive audio input, a touchscreen to receive tactile input, an accelerometer, GPS, and a display module (not shown) to display information (e.g., in the form of user interfaces).

An Application Program Interface (API) server 114 and a web server 116 are coupled to, and provide programmatic and web interfaces respectively to, one or more application servers 118. The application servers 118 host a publication system 120 and a payment system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage repositories or database(s) 126. In one embodiment, the databases 126 may comprise a knowledge database that may be updated with content, user preferences, and user interactions (e.g., feedback, surveys, etc.).

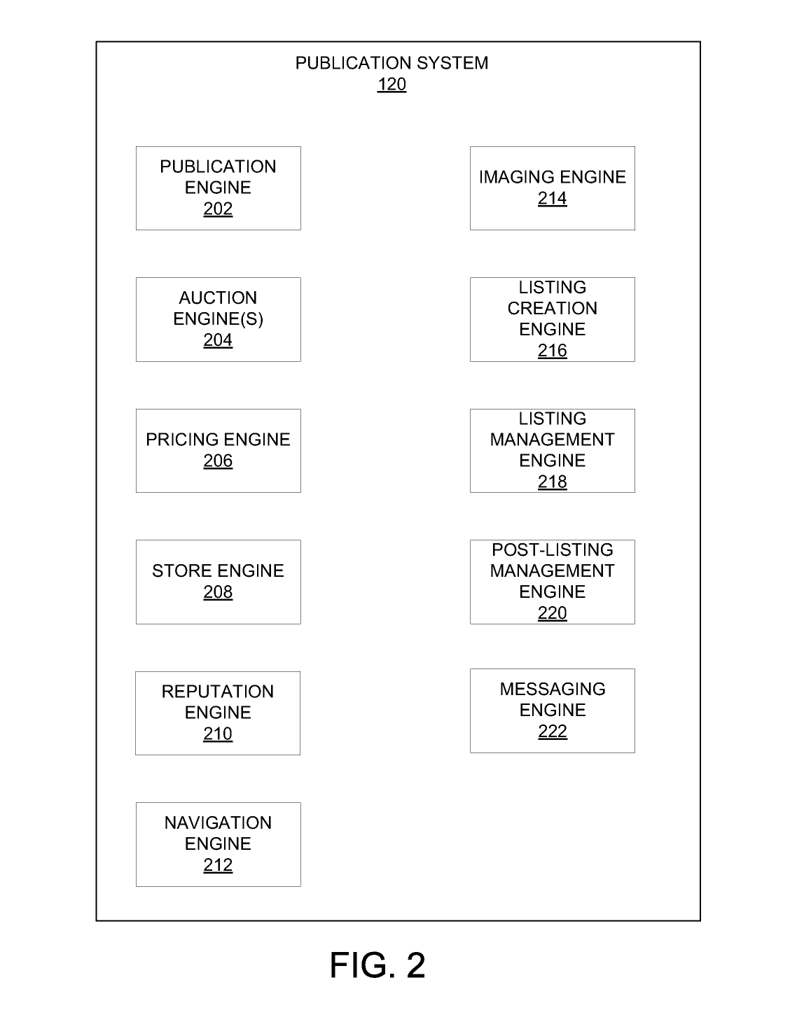

The publication system 120 publishes content on a network (e.g., Internet). As such, the publication system 120 provides a number of publication and marketplace functions and services to users that access the networked system 102. The publication system 120 is discussed in more detail in connection with FIG. 2. It should be noted that embodiments of the present invention may be applicable to non-marketplace environments.

The payment system 122 provides a number of payment services and functions to users. The payment system 122 allows users to accumulate value (e.g., in a commercial currency, such as the U.S. dollar, or a proprietary currency, such as “points”) in accounts, and then later to redeem the accumulated value for products (e.g., goods or services) that are made available via the publication system 120. The payment system 122 also facilitates payments from a payment mechanism (e.g., a bank account, PayPal, or credit card) for purchases of items via the network-based marketplace. While the publication system 120 and the payment system 122 are shown in FIG. 1 to both form part of the networked system 102, it will be appreciated that, in alternative embodiments, the payment system 122 may form part of a payment service that is separate and distinct from the networked system 102.

While the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system. The publication system 120 and payment system 122 may also be implemented as standalone systems or standalone software programs operating under separate hardware platforms, which do not necessarily have networking capabilities.

Referring now to FIG. 2, an example block diagram illustrating multiple components that, in one example embodiment, are provided within the publication system 120 of the networked system 102 (see FIG. 1) is shown. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more database(s) 126 via the one or more database servers 124, both shown in FIG. 1.

In one embodiment, the publication system 120 provides a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 120 may comprise at least one publication engine 202 and one or more auction engines 204 that support auction-format listing and price setting mechanisms (e.g., English, Dutch, Chinese, Double, Reverse auctions, etc.). The various auction engines 204 also provide a number of features in support of these auction-format listings, such as a reserve price feature whereby a seller may specify a reserve price in connection with a listing and a proxy-bidding feature whereby a bidder may invoke automated proxy bidding.

In other embodiments, the publication system 120 is directed to providing general information to a user. In these embodiments, the publication system may comprise a collection of websites and associated data repositories. For simplicity, the description of example embodiments is presented with reference to a networked marketplace. However, it will be understood that embodiments may be applicable to a non-marketplace environment. As such, not all components of the publication system 120, as described herein, may be necessary.

A pricing engine 206 supports various price listing formats. One such format is a fixed-price listing format (e.g., the traditional classified advertisement-type listing or a catalog listing). Another format comprises a buyout-type listing. Buyout-type listings (e.g., the Buy-It-Now (BIN) technology developed by eBay Inc., of San Jose, Calif.) may be offered in conjunction with auction-format listings and allow a buyer to purchase goods or services, which are also being offered for sale via an auction, for a fixed price that is typically higher than a starting price of an auction for an item.

A store engine 208 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both.

A reputation engine 210 allows users that transact, utilizing the networked system 102, to establish, build, and maintain reputations. These reputations may be made available and published to potential trading partners. Because the publication system 120 supports person-to-person trading between unknown entities, users may otherwise have no history or other reference information whereby the trustworthiness and credibility of potential trading partners may be assessed. The reputation engine 210 allows a user, for example through feedback provided by one or more other transaction partners, to establish a reputation within the network-based publication system over time. Other potential trading partners may then reference the reputation for purposes of assessing credibility and trustworthiness.

Navigation of the network-based publication system may be facilitated by a navigation engine 212. For example, a search module (not shown) of the navigation engine 212 enables searching, for example, by using keyword, free text, parametric, or any other form of searches of listings published via the publication system 120. In a further example, a browse module (not shown) of the navigation engine 212 allows users to browse various category, catalog, or inventory data structures according to which listings may be classified within the publication system 120. Various other navigation applications within the navigation engine 212 may be provided to supplement the searching and browsing applications.

In order to make listings available via the networked system 102 as visually informing and attractive as possible, the publication system 120 may include an imaging engine 214 that enables users to upload images for inclusion within listings and to incorporate images within viewed listings. The imaging engine 214 also receives images and user inputs associated with images for processing as will be discussed in more detail herein.

A listing creation engine 216 allows sellers to conveniently author listings of items or allows content providers to author content publications. In one embodiment, the listings pertain to goods or services that a user (e.g., a seller) wishes to transact via the publication system 120. In other embodiments, a user may create a listing that is an advertisement or other form of content publication.

A listing management engine 218 allows sellers to manage such listings. Specifically, where a particular seller has authored or published a large number of listings, the management of such listings may present a challenge. The listing management engine 218 provides a number of features (e.g., auto-relisting, inventory level monitors, etc.) to assist the seller in managing such listings.

A post-listing management engine 220 also assists sellers with a number of activities that typically occur post-listing. For example, upon completion of an auction facilitated by the one or more auction engines 204, a seller may wish to leave feedback regarding a particular buyer. To this end, the post-listing management engine 220 provides an interface to the reputation engine 210 allowing the seller to conveniently provide feedback regarding multiple buyers to the reputation engine 210.

A messaging engine 222 is responsible for the generation and delivery of messages to users of the networked system 102. Such messages include, for example, advising users regarding the status of listings and best offers (e.g., providing an acceptance notice to a buyer who made a best offer to a seller). The messaging engine 222 may utilize any one of a number of message delivery networks and platforms to deliver messages to users. For example, the messaging engine 222 may deliver electronic mail (e-mail), an instant message (IM), a Short Message Service (SMS), text, facsimile, or voice (e.g., Voice over IP (VoIP)) messages via wired networks (e.g., the Internet), a Plain Old Telephone Service (POTS) network, or wireless networks (e.g., mobile, cellular, WiFi, WiMAX).

Although the various components of the publication system 120 have been defined in terms of a variety of individual modules and engines, a skilled artisan will recognize that many of the items can be combined or organized in other ways. Furthermore, not all components of the publication system 120 have been included in FIG. 2. In general, components, protocols, structures, and techniques not directly related to functions of example embodiments (e.g., dispute resolution engine, loyalty promotion engine, personalization engines, etc.) have not been shown or discussed in detail. The description given herein simply provides a variety of example embodiments to aid the reader in an understanding of the systems and methods used herein.

Application of Embodiments of the Content Search Platform into the Example Network Architecture

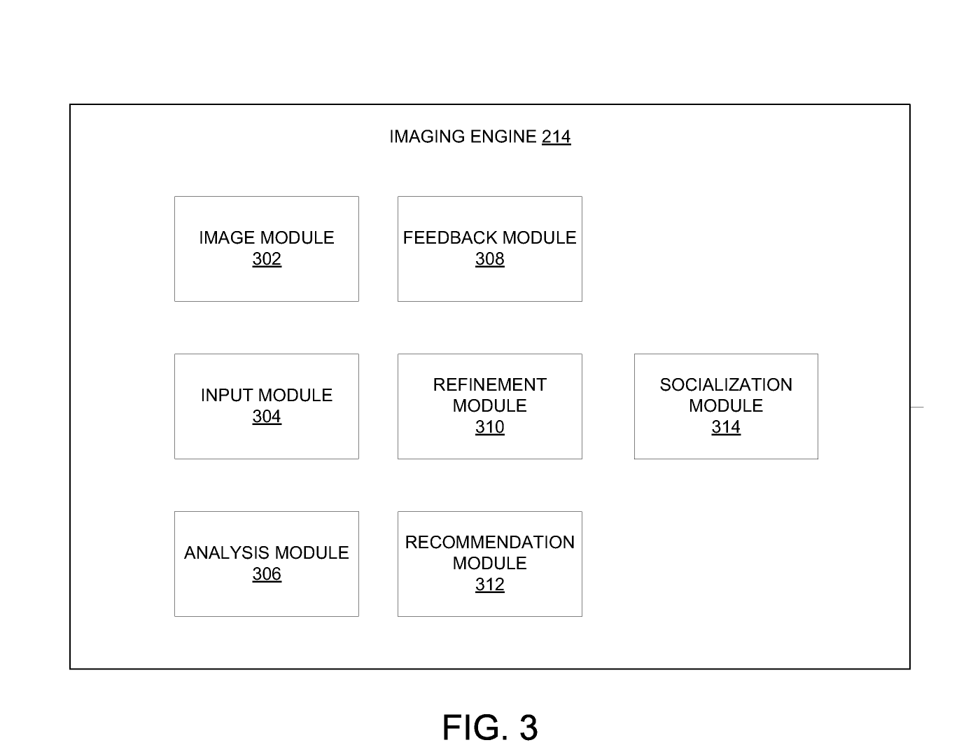

Referring now to FIG. 3, an example detailed diagram of the imaging engine 214 is shown. The imaging engine 214, alone or in conjunction with the navigation engine 212, provides mechanisms to search for content in one or more databases based on an image. The digital media comprising an image may be imported from the user device 110, be selected from an image catalog stored on a storage device associated with the networked system 102, or be digital media found anywhere on the Internet.

In example embodiments, the imaging engine 214 comprises an image module 302, an input module 304, an analysis module 306, a feedback module 308, a refinement module 310, a recommendation module 312, a results module 314, and a socialization module 316. Alternative embodiments may comprise further components or modules not directly related to example embodiments of the present invention, and thus are not shown or discussed. Furthermore, some of the components of the imaging engine 214 may be located elsewhere (e.g., in the navigation engine 212) or be located at the client device.

The image module 302 manages various processes associated with digital media and images. In some embodiments, the image module 302 receives and stores digital media imported into the networked system 102, as well as maintaining any image catalogs associated with the publication system 120. The image module 302 may also receive a selection of an image of the digital media (e.g., from an image catalog or somewhere on the Internet) from the user device. For example, an image of a model standing next to a car and holding a handbag may be selected for content analysis.

The input module 304 manages user inputs. The input comprises an input selection of an area within the selected image. The user may provide an input selection, for example, by moving a cursor over an area of interest on the image, clicking on the area of interest, or providing an input. The input selection may also be received via a touch screen or microphone (e.g., verbal command). The area of interest may be detected by the input module 304, for example, using a coordinate system associated with image. In some embodiments, the image (e.g., an image stored in an image catalog) may be pre-processed (e.g., by the analysis module 306). The pre-processing may identify various items in an image and, in some instances, apply metadata to items identified in the image. Any method of image recognition may be used to pre-process the image.

Alternatively, the analysis module 306 performs analysis of the image on-the-fly based on the input selection. In example embodiments, the analysis module 306 applies an image recognition algorithm to the selected area of interest to determine one or more entities (e.g., items) that are shown in the selected area. Generic content associated with the determined items may then be returned to the user. Because the analysis is based on the image and input selection, the generic content may be quite coarse. As such, the returned generic content may comprise general categories of the determined items. Continuing with the example, the analysis module 306 may determine that the area of interest includes items such as a tire, hub cap, and mud flap when the input selection is directed to a car tire area.

In one embodiment, the analysis module 306 looks for patterns and sequences in numerical data of the selected area of interest in the image. Because the image is composed of pixels, the analysis module 306 interprets the pixels as a series of numbers. If the analysis module 306 can identify a similar numerical series from, for example, a catalog of images, item(s) in the selected area of interest in the image are identified. In an alternative embodiment, the analysis module 306 may use metadata, text, or captions associated with the selected area of interest to identify the item(s). Further still, the analysis module 306 may analyze the image based on, for example, patterns, shapes, colors (e.g., Burberry checker design), context of the overall image, landmarks, logos, language within the image, temporal features (e.g., time of day), seasonal features (e.g., holidays), user preference information, and suggestions from other users.

The feedback module 308 provides the generic content to the user in a visual form. In example embodiments, a pop-up window or feedback cloud is provided in proximity to the selected area of interest. For example, the feedback module 308 may position a feedback cloud adjacent to or over the selected area of interest. The feedback cloud displays the generic results determined by the analysis module 306.

The feedback module 308 may also visually indicate (e.g., highlight, shade) the area of interest or items that are related to the generic content in the feedback cloud. As the cursor moves over the image, the various items in the area indicated by the cursor may be visually indicated concurrently with providing of the related generic content in the feedback cloud. Thus, for example, if the user moves the cursor from the tire area to a hand area of the model, the feedback cloud may change the feedback from tires, hub caps, and mud flaps to watches and purses (e.g., when the model is wearing a watch and holding a purse) as the same items are visually indicated (e.g., highlighted, shaded) on the image. Other information may be provided in the feedback cloud which may not be directly related to the items in the image, such as, discounts, promotions, payment, and warranty information.

In embodiments where the items in the image are largely depicted or the analysis module 306 is able to detect only a single item, more specific content may be provided in the feedback cloud. For example, if the analysis module 306 only detects the watch on the model, the feedback cloud may indicate several brands of watches, various parts of a watch, or watch related items (e.g., watchbands, watch batteries, watch repair kits, authorized repair centers, replacement parts).

The refinement module 310 allows refinement attributes to be applied to the generic results. In some embodiments, the refinement module 310 may propose attributes from which the user may select in order to refine the generic content. These attributes may be provided in the same feedback cloud as the generic content. In other embodiments, the user may provide attributes or attribute ranges by manually entering the attributes. The attributes may comprise, for example, brands, quantity, size, color, price range, time (e.g., end time for an auction), shipping terms (e.g., speed, costs), or any other information which may be used to narrow the content down to more specific results (e.g. updated content). Thus, continuing with the example, the user may provide refinement attributes for a watch such as “gold,” “waterproof,” and “Titan.” The refinement attributes may be determined based on attributes associated with the generic content in the database 126.

In some embodiments, the updated content may be affected by the recommendation module 312. If the user is known to the publication system 120 (e.g., logged in with the publication system 120), then user preferences for the user may be accessed by the recommendation module 312. The user preferences may include past transaction history (e.g., purchase history) and past search history (e.g., click-throughs, previous terms searched), location, personal attributes (e.g., age, sex, marital status). For example, if the user has purchased a certain brand in the past, then the updated content result may be skewed to provide those results higher in the feedback cloud or provide that brand as a further refinement attribute. The recommendation module 312 may also provide refinement attributes based on recommendations from other users. For example, the user may specify a threshold feedback percentage that a recommendation from other users should exceed in order for the recommendation module 312 to incorporate the recommendation. The feedback percentage may be based on, for example, ratings from other users of the publication system 120 or number of purchases based on the recommendation.

The analysis module 306 takes the refinement attributes received or provided by the refinement module 310 and any recommendations determined by the recommendation module 312 and derives updated content for the user. Specifically, the analysis module 306 accesses the databases 126 and applies the received attributes and any recommendations to determine more specific matches in the database 126. In one embodiment, the database 126 comprises dynamically updated (e.g., current) content, such as current item listings of an auction site. As such, the determined matches comprise up-to-date content. The updated content is derived by accessing a continuously updating database of content and applying the refinement attributes and recommendations to the content in the continuously updating database.

The updated content may be a listing of specific content pages (e.g., a list of item listings of items for sale or auction, a list of websites/web pages that contain the specific content, or a list of individuals that satisfy the refinement attributes). Alternatively, the updated content may comprise content which may require further refinement. Any number of refinement iterations may be performed. Continuing with the example, the results module 314 may return listings of gold Titan watches that are waterproof. The content may be returned within a pop-up window, the feedback cloud, or anywhere else on a display showing the image.

As noted above, the results of the content analysis system may comprise any information that is found in the networked system 102. For example, the result module 314 may provide a website for Titan or a Wikipedia page directed to the history of Titan watches.

The socialization module 314 manages social aspects of the content analysis system. In example embodiments, the user may share one or more results of the content analysis system with others (e.g., via e-mail, wish lists, watch lists). For example, the user may select a listing for a Titan watch that the user would like and suggest it to a friend for purchase. Subsequently, the friend may merely complete the transaction (e.g., accept the offer in the listing and pay through PayPal). Alternatively, the user may propose an item as a gift for someone else, and the other person merely needs to agree to the gift or provide conditions for acceptance (e.g., based on item, size, color, etc.).

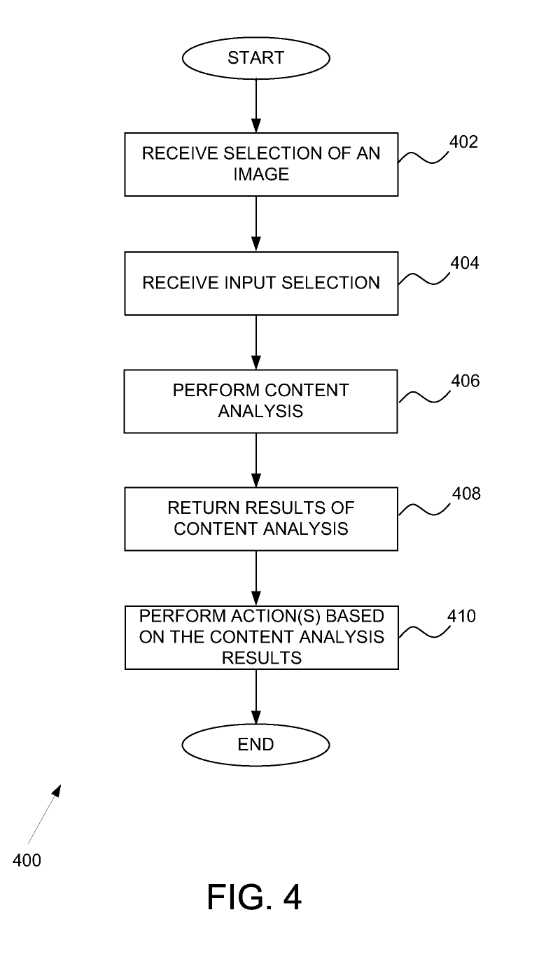

FIG. 4 is a flow diagram of an example high-level method 400 for searching content based on an image. In operation 402, a selection of an image of a digital media (e.g., a photograph, video) is received from the client device 110. The image may be selected, for example, by the user importing the image from their client device 110, by the user selecting the image from an image catalog associated with the publication system 120, or by the user selecting the image from anywhere on the Internet. The image module 302 receives the selection and may, in some cases, perform some pre-processing of the image.

A user input selection is received from the client device 110 in operation 404. The input selection is an indication of an area of interest in the selected image. In example embodiments, the input module 404 detects an area on the image that the user is indicating using an input device (e.g., mouse, keyboard, microphone, touch screen).

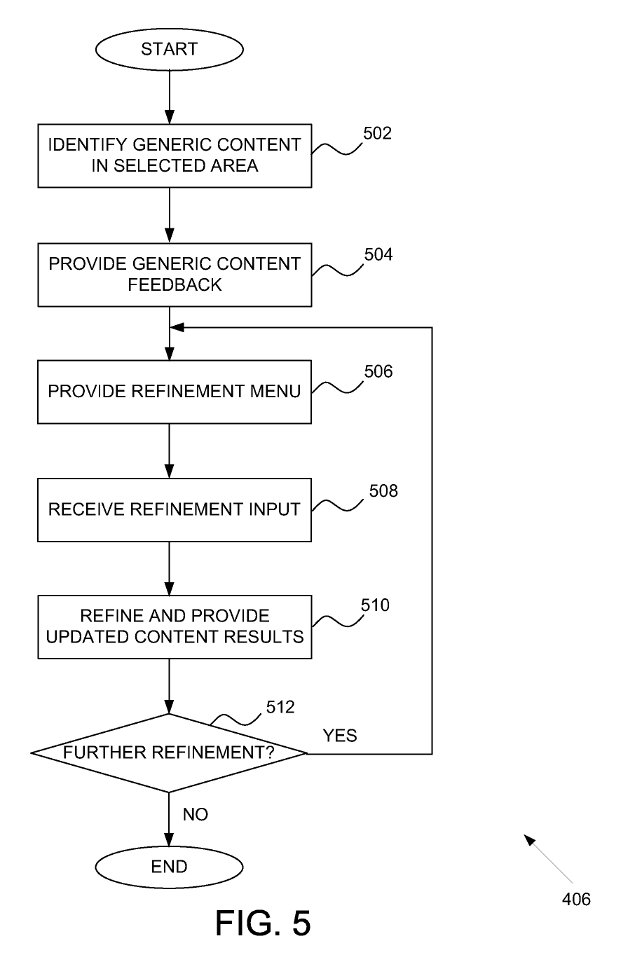

Based on the input selection, content analysis is performed in operation 406. The content analysis may include a series of refinements in order to arrive at a final result set comprising refined content. Content analysis will be discussed in more detail in connection with FIG. 5.

The results of the content analysis are returned to the client device 110 in operation 408. For example, the results may be returned and displayed in a pop-up window, the feedback cloud, or any other location on a display of the client device 110. The results may also be stored for later access. For example, the stored results may be used for comparison with a later search or purchase history. The results may include one or more item listings of items for sale or auction, websites, articles or documents, or any other content that is related to the selected area of interest.

In operation 410, actions may be performed based on the result set. In one embodiment, the user may purchase an item from an item listing or access a web site/webpage provided in the result set. In other embodiments, the user may send one or more results from the result set to other users (e.g., sharing the results on a watch list or wish list, sending a result to purchase for the user, or sending a result as a potential gift), for example, via the socialization module 314. In social networking or dating embodiments, the user may contact one or more individuals listed in the result set (e.g., using VoIP, e-mail, video, or text messaging).

FIG. 5 is a flow diagram of an example detailed method for performing content analysis (e.g., operation 406). At operation 502, an initial set of generic content is identified. The analysis module 306 performs a generic analysis of the image based on the input selection. In example embodiments, the analysis module 306 performs image recognition on the area of interest to determine one or more items that are shown in the image. In other embodiments, metadata associated with items in the indicated area may be used to provide the generic content.

Generic content feedback is provided in operation 504. The feedback module 308 provides the generic feedback, for example, in the form of a pop-up window or feedback cloud adjacent to the area of interest indicated by the input selection. The feedback cloud may display the generic results determined by the analysis module 306. Concurrently with the feedback cloud, the items being indicated in the cloud may be visually indicated (e.g., highlighted, shaded, change in color). In some embodiments, the generic content may comprise a larger result set which is subsequently refined into a smaller result set.

A refinement menu is provided in operation 506. The refinement menu comprises proposed refinement attributes from which the user may select or one or more fields where the user may manually enter refinement attributes. The attributes may comprise, for example, brands, quantity, size, color, price range, discounts, promotions, age, qualities, or any other information which may be used to narrow the content down to more specific results (e.g. updated content). In some embodiments, the refinement menu is provided concurrently with the generic content in the feedback cloud. Alternatively, the refinement menu may be provided separately from the feedback cloud.

It should be noted that as the cursor moves over the image, the content in the feedback cloud may change. Therefore, operations 404, 502, 504, and 506 may be repeated until the user decides to provide refinement attributes. The iteration of operations 404, 502, 504, and 506 may be useful when, for example, the user does not select the proper area in their first input selection.

Refinement input is received in operation 508. Thus, for example, the user selects one or more refinement attributes for a generic content in order to refine the generic content into more specific content directed to the user's interest from a menu of refinement attributes. These refinement attributes are received by the refinement module 310 in operation 508.

The generic results are refined and updated content results are provided in operation 510. The analysis module 306 takes the received refinement attributes and derives updated content for the user. The updated content may be a listing of specific content pages (e.g., a list of item listings for items for sale or auction or a list of websites/web pages that contain the specific content) shown in the feedback cloud. In some embodiments, recommendations may be factored into the determination of the updated content updated content results for the user.

In operation 512, a determination is made as to whether further refinement is necessary. When the updated content results comprise content that is still too high level for the user, the user may choose to further refine the content results and the method 406 returns to operation 506. Any number of refinement iterations may be performed. In these embodiments, the feedback cloud may comprise both the updated content and a refinement attribute menu.

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Medium

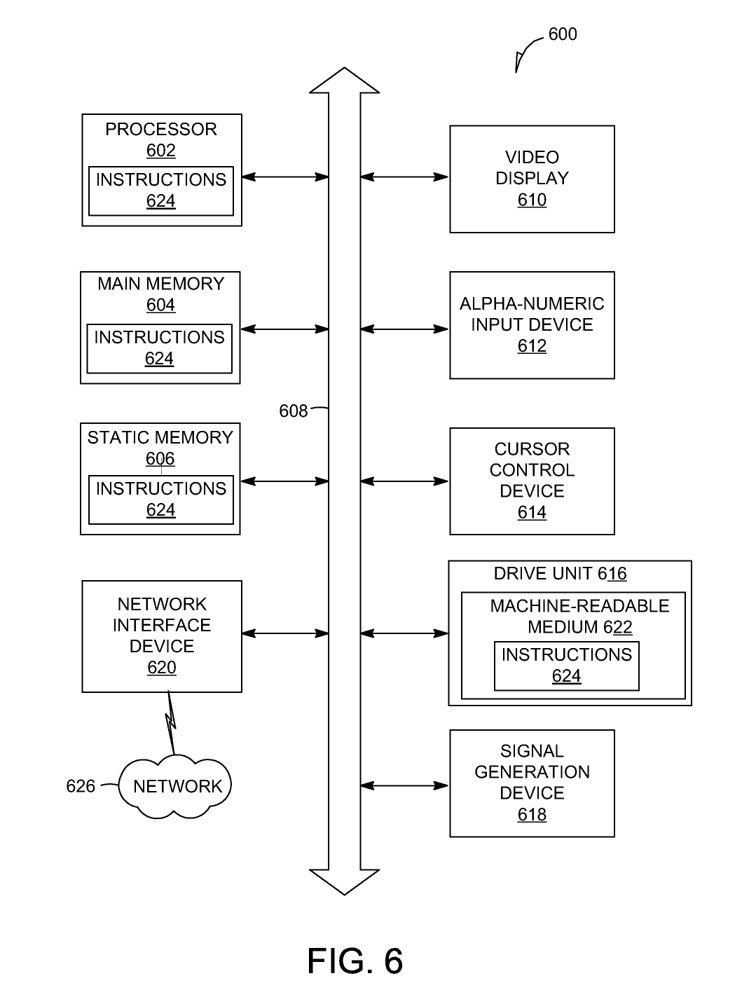

With reference to FIG. 6, an example embodiment extends to a machine in the example form of a computer system 600 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 may include a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). In example embodiments, the computer system 600 also includes one or more of an alpha-numeric input device 612 (e.g., a keyboard), a user interface (UI) navigation device or cursor control device 614 (e.g., a mouse), a disk drive unit 616, a signal generation device 618 (e.g., a speaker), and a network interface device 620.

### Machine-Readable Storage Medium

The disk drive unit 616 includes a machine-readable storage medium 622 on which is stored one or more sets of instructions 624 and data structures (e.g., software instructions) embodying or used by any one or more of the methodologies or functions described herein. The instructions 624 may also reside, completely or at least partially, within the main memory 604 or within the processor 602 during execution thereof by the computer system 600, with the main memory 604 and the processor 602 also constituting machine-readable media.

While the machine-readable storage medium 622 is shown in an example embodiment to be a single medium, the term “machine-readable storage medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 624 may further be transmitted or received over a communications network 626 using a transmission medium via the network interface device 620 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving an input selection indicating an area of an image;
determining, using one or more processors, one or more entities associated with the selected area;
retrieving content from a database based on the determined one or more entities, the content being dynamically updated content stored in the database; and
providing the retrieved content for display in association with the selected area of the image.

2. The method of claim 1, wherein receiving the input selection comprises receiving an indication of a position from one or more of a mouse, keyboard, microphone, camera, or touch screen.

3. The method of claim 1, wherein the database comprises an item inventory database of items available for purchase.

4. The method of claim 1, wherein the database comprises a social database including information about people.

5. The method of claim 1, wherein the entities comprise one or more of items, people, or services.

6. The method of claim 1, wherein the retrieved content comprises at least one of a category, product name, brand, price, quantity available, discount, promotion, shipping terms, images, or item attributes.

7. The method of claim 1, wherein the retrieved content comprises one or more item listings of the determined one or more items for sale.

8. The method of claim 1, further comprising determining refinement attributes applicable to the retrieved content and providing the determined refinement attributes in a refinement menu.

9. The method of claim 8 wherein the refinement attributes comprise one or more of product name, brand, price range, quantity available, time, color, or size.

10. The method of claim 1, further comprising refining the retrieved content using the at least one selected refinement attribute, the refining based on a search of the database based on the retrieved content and the at least one selected refinement attribute.

11. The method of claim 1, further comprising initiating a purchase transaction based on the retrieved content.

12. The method of claim 1, wherein providing the retrieved content comprises providing the retrieved content in a feedback cloud.

13. The method of claim 1, further comprising refining the retrieved content based on at least one of user preferences and recommendations exceeding a recommendation threshold.

14. A system comprising:
an input module to receive a selection of an area of an image;
an analysis module to determine, using one or more processors, one or more entities associated with the selected area and to retrieve content from a database based on the determined one or more entities, the content being dynamically updated content stored in the database; and
a feedback module to provide the retrieved content for display in association with the selected area of the image.

15. The system of claim 14, further comprising a refinement module to determine refinement attributes applicable to the retrieved content and to provide the determined refinement attributes in a refinement menu.

16. The system of claim 14, further comprising a recommendation module to determine recommendations to be applied in determining updated content.

17. The system of claim 14, further comprising a socialization module to manage sharing of the retrieved content with other users.

18. The system of claim 14, wherein the analysis module is further to refine the retrieved content using one or more of user preferences, recommendations exceeding a threshold, or at least one refinement attribute.

19. A machine-readable storage medium in communication with at least one processor, the machine-readable storage medium storing instructions which, when executed by the at least one processor, performs a method comprising:
receiving an input selection indicating an area of an image;
determining, using one or more processors, one or more entities associated with the selected area;
retrieving content from a database based on the determined one or more entities, the content being dynamically updated content stored in the database; and
providing the retrieved content for display in association with the selected area of the image.

20. The machine-readable storage medium of claim 19, wherein the method further comprises determining refinement attributes applicable to the retrieved content and providing the determined refinement attributes in a refinement menu.

21. The machine-readable storage medium of claim 19, wherein the method further comprises refining the retrieved content using at least one selected refinement attribute, the refining based on a search of the database based on the retrieved content and the at least one selected refinement attribute.

22. The machine-readable storage medium of claim 19, wherein the method further comprises refining the retrieved content based on at least one of user preferences and recommendations exceeding a recommendation threshold.
